(19) United States
(12) Patent Application Publication
(10) Pub. No.: US 2008/0018929 A1
(43) Pub. Date: Jan. 24, 2008

(54) IMAGE FORMING APPARATUS AND METHOD OF CONTROLLING THE SAME APPARATUS

(75) Inventor: Naomi Nakamura, Abiko-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/736,918

(22) Filed: Apr. 18, 2007

(30) Foreign Application Priority Data
Jun. 19, 2006 (JP) 2006-168564

(51) Int. Cl. G06F 3/12

(52) U.S. Cl. 358/1.15

(57) ABSTRACT

An image forming apparatus includes a scanner unit configured to read an original document, a memory unit configured to store image data, a printer unit configured to print image data, and an analysis unit configured to analyze a print specification sheet read by the scanner, wherein when the analysis unit determines that in a first print specification sheet there is no instruction to read a second print specification sheet, the printer unit prints image data based on the first print specification sheet, and when the analysis unit determines that in the first specification sheet there is an instruction to read a second print specification sheet, the printer unit prints image data specified on the first and second print specification sheets based on the first or the second print specification sheet.

### BACKGROUND OF THE INVENTION

1. Field of the Invention

The present invention relates to an image forming apparatus that reads and analyzes an original document in which print control instructions are written, and prints data according to the print control instructions.

2. Description of the Related Art

In sheet scan systems, a user utilizes the scan function of a multifunction peripheral (MFP) to write print control instructions on a mark-sensing sheet with a pencil or a pen, and the MFP performs printing according to analyzed print control instructions. As the sheet scan method, various technologies have been disclosed. For example, a Japanese Patent Application Laid-Open No. 2004-34584 proposes an input/output device which has an image reading unit to read a recording instruction before the start of recording, and performs the recording according to the recording instruction.

Japanese Patent Application Laid-Open No. 2005-236983 proposes a method for printing a proof sheet which can specify images to be recorded, a number of images to be copied, record sheet size, and an image correction processing. After the proof sheet marked by the user is read and the marked items are analyzed, images are recorded according to the marked instruction.

As a result of the increase in the storage capacity of memory cards, the number of images that can be stored on a memory card has increased. Accordingly, in order to specify images that the user wishes to print, it is necessary to first print a number of mark-sensing sheets. Even if print settings are the same, the user needs to specify images to be printed, the number of copies, a recording paper size, and an image correction processing on each mark-sensing sheet respectively.

FIG. 3 illustrates an example of a conventional mark-sensing sheet MS11. A print mode setting section 301 includes marking items which specify a recording paper size, a paper media type, and bordered or borderless printing. The items are marked by filling in marking areas. Further, the print mode setting section 301 includes marking items for date print and automatic image correction. For date print, a marking area is provided to specify whether to superpose a date on images to show the date on which photos were taken. For automatic image correction, a marking area is provided to specify whether to perform automatic image correction so that optimum print quality can be realized based on histograms of image luminance and saturation, and photo-taking conditions included in image data.

Image information 302 includes sample images in a reduced form that can be specified by a mark-sensing sheet MS11, and also includes marking areas to specify shooting dates and a number of prints. Image number range 303 is a bar code indicating from which number to which number the images are specified by the mark-sensing sheet MS11 in a memory card.

When printing image data in a memory card using the sheet scan system, the user needs to perform an operation to print this mark-sensing sheet MS11. Thus, images can be printed easily by marking on a printed mark-sensing sheet MS11. However, since the number of images that can be stored in a memory card has increased, a number of mark-sensing sheets MS11 need to be printed in order for current sheet scan systems to print many images.

As illustrated in the mark-sensing sheet MS11 in FIG. 3, print settings for images on each mark-sensing sheet MS11 can be specified only by the print mode setting section 301 on the mark-sensing sheet MS11. Therefore, it is necessary to mark the same print settings on every mark-sensing sheet MS11. Moreover, if the user wishes to change some of the recording conditions on the used mark-sensing sheet MS11 or change print settings only to one image, it is also necessary to mark print settings which are not changed.

### SUMMARY OF THE INVENTION

The present invention includes an image forming apparatus in which it is possible to print images by marking print settings only on one mark-sensing sheet without marking print settings on any other mark-sensing sheets, even if a plurality of mark-sensing sheets is used and print settings are made for a plurality of images.

According to an aspect of the present invention, an image processing apparatus includes a scanner unit configured to read an original document a memory unit configured to store image data, a printer unit configured to print image data, and an analysis unit configured to analyze a print specification sheet read by the scanner, wherein when the analysis unit determines that in a first print specification sheet there is no instruction to read a second print specification sheet, the printer unit prints image data based on the first print specification sheet, and when the analysis unit determines that in the first specification sheet there is an instruction to read a second print specification sheet, the printer unit prints image data specified on the first and second print specification sheets based on the first or the second print specification sheet.

In another aspect of the present invention a method for controlling an image forming apparatus having a scanner configured to read an original document, a memory unit configured to store image data, and a printer unit configured to print image data, the method includes analyzing a first print specification sheet, printing image data based on a first print specification sheet if an analysis result indicates that in the first print specification sheet there is no instruction to read a second print specification sheet, and printing image data specified by the first and the second print specification sheets based on the first or the second print specification sheet, if the analysis result indicates that in the first print specification sheet there is an instruction to read the second specification sheet.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B are perspective views illustrating external appearances of a multifunctional peripheral (MFP) as an example of an image forming apparatus according to a first exemplary embodiment of the present invention.

FIG. 2 is a block diagram illustrating the structure of the (MFP) according to the first exemplary embodiment.

FIG. 3 is a diagram illustrating an example of a conventional mark-sensing sheet.

FIG. 4 is a diagram illustrating a mark-sensing sheet according to the first exemplary embodiment.

FIG. 5 is a diagram illustrating a mark-sensing sheet according to a second exemplary embodiment of the present invention.

FIG. 6 is a diagram illustrating a file list and print mode settings according to the first exemplary embodiment.

FIG. 7 is a diagram illustrating a file list and print mode settings according to the second exemplary embodiment.

FIG. 8 is a flowchart illustrating all steps in the sheet scan control method according to the first exemplary embodiment.

FIG. 9 is a flowchart illustrating an operation procedure of a mark-sensing sheet analysis process in the flowchart illustrated in FIG. 8.

### DETAILED DESCRIPTION OF THE EMBODIMENTS

Various exemplary embodiments, features, and aspects of the invention will be described in detail below with reference to the drawings.

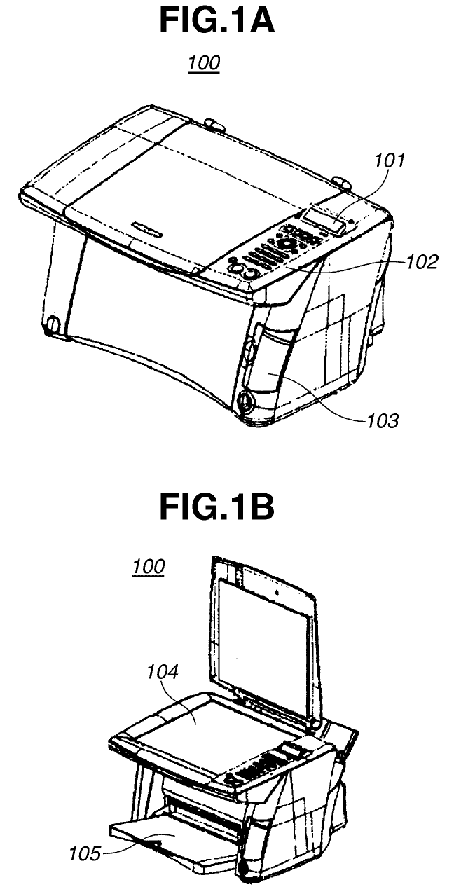

FIGS. 1A and 1B are perspective views illustrating external appearances of a multifunctional peripheral (MFP) 100 as an example of an image forming apparatus according to a first embodiment of the present invention.

The MFP 100 includes a display unit 101, an operation unit 102, a card interface 103, a reading unit 104, and a recording unit 105.

As illustrated in FIGS. 1A and 1B, the MFP 100 is constructed such that the reading unit 104 and the recording unit 105 are enclosed in a housing. When copying a document or performing a sheet-scan process in the present embodiment, the user opens the reading cover of the reading unit 104 and places a document on the glass surface. Then, the user closes the reading cover, opens the recording cover of the recording unit 105, and presses the start key on the operation unit 102 to execute a desired function.

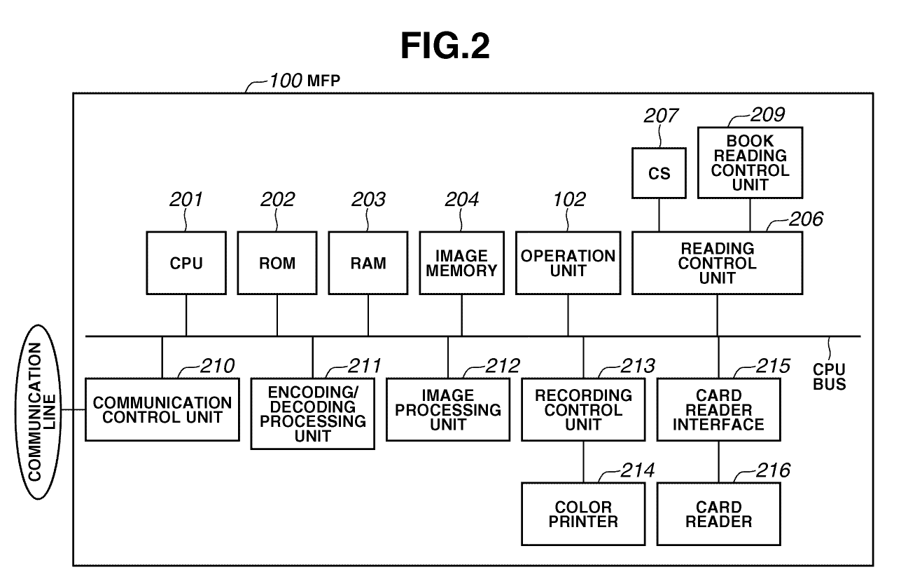

FIG. 2 is a block diagram illustrating the structure of the MFP 100. The MFP 100 includes a central processing unit (CPU) 201, a read only memory (ROM) 202, a random access memory (RAM) 203, an image memory 204, an operation unit 102, a reading control unit 206, a contact image sensor (CS) 207, a book reading control unit 209, a communication control unit 210, and a encoding/decoding processing unit 211. The MFP 100 further includes an image processing unit 212, a recording control unit 213, a color printer 214, a card reader interface unit 215, and a card reader 216.

The CPU 201 is a system control unit that controls the MFP 100. The ROM 202 stores a control program of the CPU 201 and an operating system (OS) program. The RAM 203 is a static random access memory (SRAM) or the like, and stores program control variables. The RAM 203 further stores setting values input by the operator, equipment management data, and the buffers for various kinds of work. The image memory 204 is a dynamic random access memory (DRAM) or the like, and accumulates image data.

In the present embodiment, the various control programs stored in ROM 202 perform software control such as scheduling and task switch under the management of the OS stored in ROM 202. The operation unit 102 includes various kinds of keys, light emitting diodes (LEDs), and liquid crystal displays (LEDs). The operation unit 102 performs various input operations by the operator, and displays a screen in connection with the input operations, the operating states of the functions and the condition of the image forming apparatus.

The reading control unit 206 controls the CS 207 and the book reading control unit 209 to read an original document placed on the reading unit 104. Image data that is read is stored in RAM 203. The CS 207 optically reads the original, converts image data into an electrical image signal that is digitized by analog-to-digital (AD) conversion. After this process, digital data is subjected to image processing, such as shading correction and device-dependent gamut correction, and the high definition image data is output to RAM 203.

The book reading control unit 209 controls a motor using a motor drive table specified by the reading control unit 206 in synchronization with a motor step speed. The book reading control unit 209 reads a sheet of an original document by moving the CS 207 in parallel with the original document. In the present embodiment, the reading control unit 206 performs book reading control to scan the original placed on the platen. In another embodiment, sheet reading control is performed for reading the original while it is being transferred.

The communication control unit 210 includes a modulator/demodulator (MODEM), and a network control unit (NCU) The communication control unit 210 in the present embodiment is connected to an analog communication line (PSTN). The communication control unit 210 performs facsimile communication control in T30 protocol, and line control for outgoing call and incoming call on a communication line. Please note that any communication interface and protocol that would enable practice of the invention is applicable.

The encoding/decoding processing unit 211 performs encoding/decoding processing and scaling processing on image data managed by the MFP 100. Color image data is compressed and decompressed according to Joint Photographic Experts Group (JPEG). Monochrome image data is compressed and decompressed according to Modified Read (MR).

The image processing unit 212 performs resolution conversion, such as mm/inch resolution conversion, for image data, analysis of image data stored in RAM 203, image processing for color correction to record the image data with optimum picture quality based on a result of the analysis, and rotation of image data. The image processing unit 212 further performs image-data conversion, such as analyzing of a page description language and bitmap rasterization of character data.

The recording control unit 213 performs control so that image data stored in RAM 203 is read out and is subjected to various kinds of image processing such as smoothing, record density correction, and color correction in the image processing unit 212. Further, the recording control unit 213 converts the image data into print data which the color printer 214 can print, and controls each record page.

The color printer 214 is a laser beam printer or an inkjet printer, and receives print data generated by the recording control unit 213, and prints the received print data on a recording paper.

The card reader interface 214 is an interface for establishing connection with the card reader 216, and controls reading of data from a memory card in the card reader 216 and writing of data onto the memory card in the card reader 216. In the present embodiment, the card reader interface 215 is a universal serial bus (USB) interface any interface that would enable practice of the present invention is applicable.

The card reader 216 is compatible with USB interface storage class and provided with insertion slots for memory cards, such as a Compact Flash®, a secure digital (SD) card, and a memory stick. The card reader 216 notifies the CPU 201 via a hardware interrupt when a card is inserted or withdrawn.

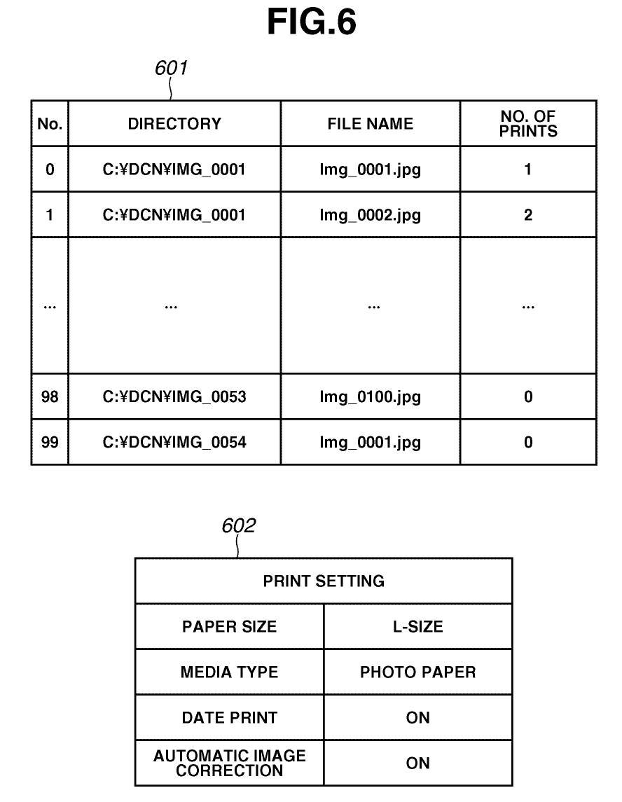

FIG. 6 is a diagram illustrating a file list 601 and print mode settings 602 according to the present embodiment. When the CPU 201 detects that a memory card has been inserted into the card reader 216, the file list 601 is allocated to RAM 203. When the CPU 201 detects that a memory card has been inserted in the card reader 216, the CPU 201 searches the memory card for a print target image through the card reader interface unit 215. Searched files are sorted in the order of folder names and file names. The sorted files are stored in an order corresponding to file numbers and classified by folder names and file names.

At this time, the number of prints of each file name in the file list 601 is initialized to zero. FIG. 6 illustrates the list sorted in the order of file names, but the list can also be sorted in the order of photo-taking dates. In print mode settings 602, when the file list 601 is generated, each setting is initialized to a predetermined initial value. Results of analysis of the mark-sensing sheets are set to the file list 601 and the print mode settings 602, so that the consistency of data can be checked after analysis results of all mark-sensing sheets are obtained. Images for which the number of prints has been set can be printed according to the print mode settings 602.

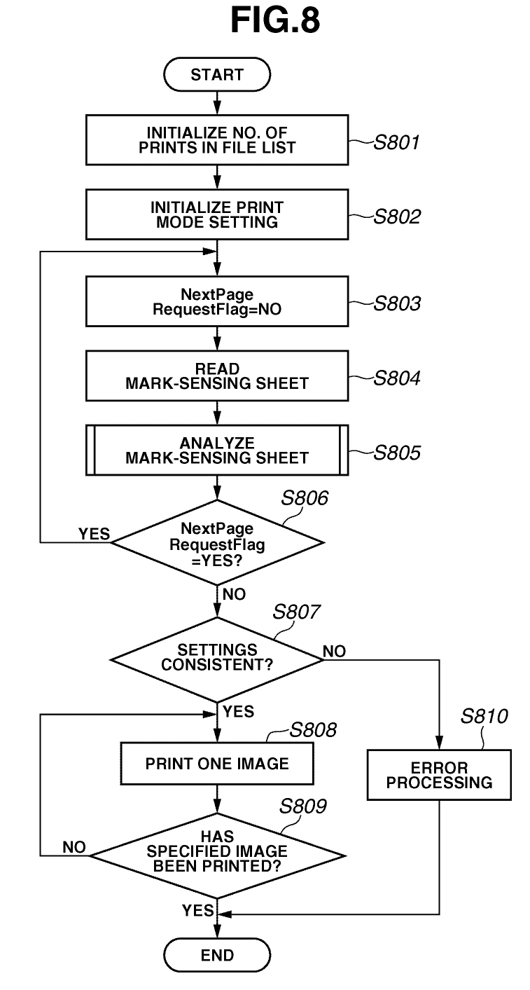

FIG. 8 is a flowchart illustrating the operation of the sheet scan control system of the present embodiment. The operation is executed when the reading cover of the reading unit 104 is opened, an original document is placed on the glass plate, and image print according to the mark-sensing sheet is selected on the operation unit 102.

When image print according to the mark-sensing sheet is elected, the numbers of prints in the file list 601 are initialized to zero (step S801), and the items of print mode settings 602 are initialized to predetermined values (step S802). Then, the variable of NextPageRequestFlag used in determining whether to read the next mark-sensing sheet is initialized (step S803). Reading resolution and a number of colors are specified to the reading control unit 206, and the mark-sensing sheet on the reading unit 104 is read (step S804). Image data read from the mark-sensing sheet is stored as image data for one sheet in the image memory 204. The mark-sensing sheet is analyzed to analyze stored image data on the mark-sensing sheet (step S805).

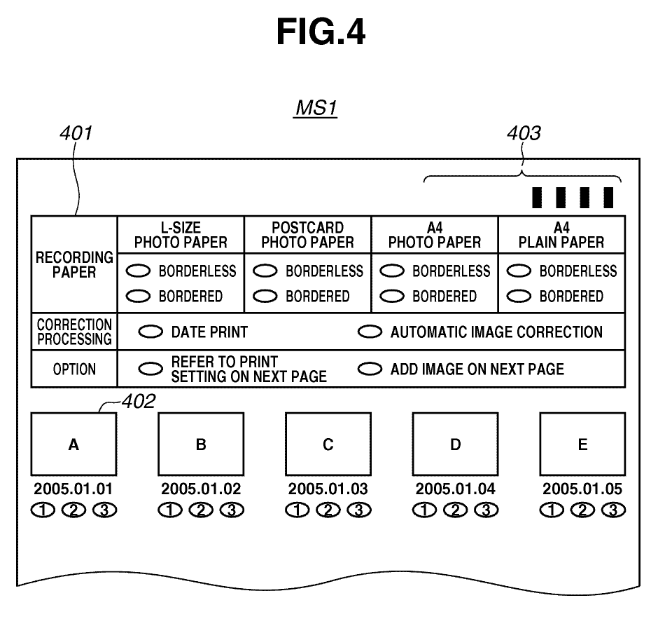

FIG. 4 is a diagram illustrating a mark-sensing sheet MS1 according to the present embodiment. When analyzing a mark-sensing sheet, the print mode in the print mode settings 401 is analyzed. If “Refer to print setting on the next page” or “Add image on the next page” is marked, the variable of NextPageRequestFlag is set to YES. If, in step S806, the variable of NextPageRequestFlag is YES, the process returns to step S803 to read the next mark-sensing sheet. At this time, an indication is displayed on the display unit 101 to prompt the user to place a mark-sensing sheet on the reading unit 104 and press the start key on the operation unit 102.

When the user changes the mark-sensing sheet and presses the start key, the process takes place again starting with step S803. If, in step S806, the variable of NextPageRequestFlag is NO, it is determined that reading of the next mark-sensing sheet is not specified, and the process proceeds to step S807.

In step S807, a check is made to see if there is inconsistency in marked print mode settings and a marked print image. For example, it is checked whether recording paper size, media type, and bordered or borderless printing are marked doubly or more. In the present embodiment, there is no item that could be doubly selected.

If settings necessary for print control have not been made, this condition is determined to be inconsistent. When inconsistency is determined in step S807, the process is terminated and goes to an error process (step S810). In the error process (step S810), the display unit 101 displays the inconsistency and illustrates detailed contents of an error. If, in step S807, consistency is confirmed, one or more images in the file list 601 are printed according to print mode settings 602 (step S808). The print process in step S808 is performed until all images are printed. After all specified images have been printed (YES in step S809), the process is terminated.

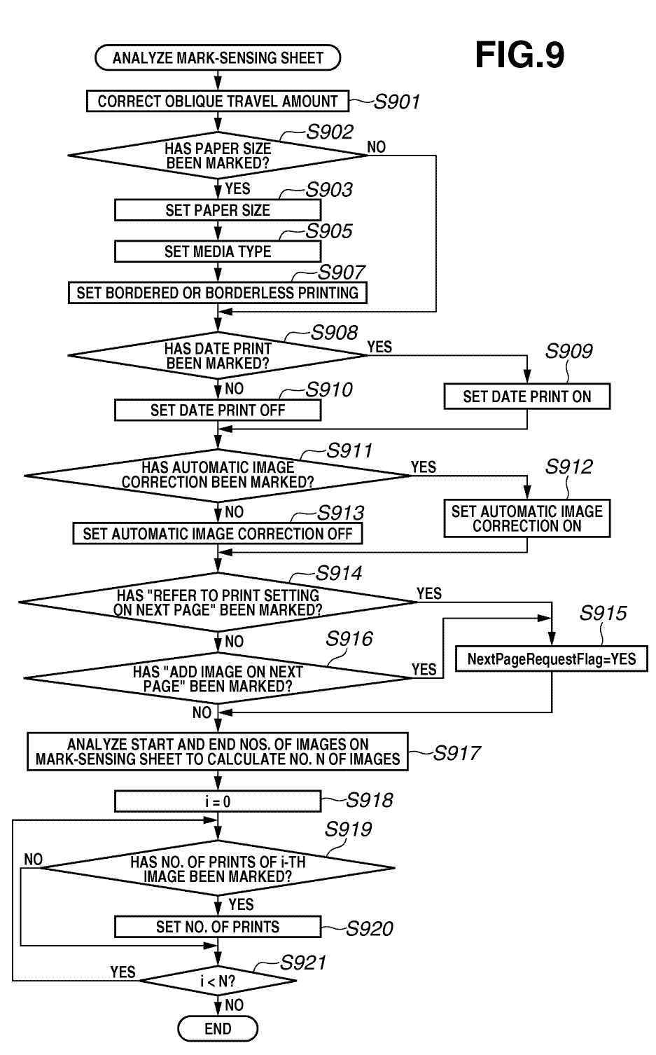

FIG. 9 is a flowchart illustrating the steps of the mark-sensing sheet analysis (step S805) in the flowchart of FIG. 8. The mark-sensing sheet analysis includes measuring an oblique travel amount that occurs when the mark-sensing sheet is read by the reading control unit 206, based on image data of the mark-sensing sheet stored in the image memory 204, and then adjusting marking positions (step S901).

Then, the print mode settings 401 are analyzed. In the print mode settings 401, if the items related to recording paper are marked, that means a recording paper size, a media type, and bordered or borderless printing have been selected. Therefore, first, it is checked if a recording paper size has been marked (step S902). If a recording paper size has been marked (YES in step S902), the recording paper size marked at the print mode settings 602 is set (step S903).

Next, a media type is set (step S905). Then, bordered or borderless print is set (step S907), and the correction processing is analyzed. If a recording paper size has not been marked in step S902, the process moves to step S908.

In the conventional sheet scan system, the print mode is established with one mark-sensing sheet. Accordingly, if a recording paper has not been marked as in the present embodiment, the process will end in an error termination. However, in the present embodiment, it is possible that the next mark-sensing sheet will be read. thus, a decision is not made as to whether to go to the error process.

In step S908, a decision is made if date print is marked. If it is decided in step S908 that date print is marked, date in the print mode setting 602 is set to ON (step S909). If date print is not marked in step S908, date in the print mode settings 602 is set to OFF (step S910).

Then, in step S911, it is determined whether automatic image correction is marked. If automatic image correction is marked (YES in step S911), the automatic image correction in the print mode settings 602 is set to ON (step S912). If the automatic image correction has not been marked (NO in step S911), the automatic image correction in the print mode settings 602 is set to OFF (step S913).

In the present embodiment, if date print or automatic image correction is not marked, the unmarked function is OFF. If date print and automatic image correction are marked, the marked functions are ON. Therefore, the results of a new mark-sensing sheet are written over the results of the previous mark-sensing sheet. However, it can be arranged such that if the date print or the automatic image correction is ON in the old mark-sensing sheet, this active function can be prevented from becoming OFF in a new mark-sensing sheet even if this function is not marked in the new mark-sensing sheet.

As a method of specifying date print or automatic image correction, either ON or OFF is selected. If neither ON nor OFF is marked on a new mark-sensing sheet, no setting is made, and therefore the current settings on the previous mark-sensing sheet can be maintained ON.

Then, the option items in the print mode settings 401 are analyzed. In step S914, it is determined whether “Refer to print settings on the next page” is marked. If it is marked (NO in step S914), it is determined in step S916 whether “Add image on the next mage” is marked. If it is not marked (NO in step S916), it is not necessary to read the mark-sensing sheet on the next page, so that NO is maintained as the variable of NextPageRequestFlag, and the process proceeds to step S917. If it is determined that the message in step S914 or step S916 is marked, it is necessary to read the mark-sensing sheet on the next page, so that the variable of NextPageRequestFlag is set to YES (step S915), and the process proceeds to step S917.

Therefore, after the mark-sensing sheet analysis process has been finished, it is possible to read the mark-sensing sheet again. Then, an image to be printed is searched for. In step S917, the bar code 403 printed on the mark-sensing sheet illustrated in FIG. 4 is analyzed. The head number and the last number of images specified as print objects by the mark-sensing sheet are obtained, and a number of images N specified as print objects on the mark-sensing sheet is calculated. In step S918, the count number is initialized to 0 to analyze the number of images calculated in step S917.

The marked items of the i-th image information are analyzed, and it is determined whether the number of prints is marked (step S919). If the number of prints has been set (YES in step S919), this number is set as the number of prints in the file list 601 (step S920). This process is performed on N pieces of images printed on the mark-sensing sheet. When all of N images have been confirmed (NO in step S921), the process is finished.

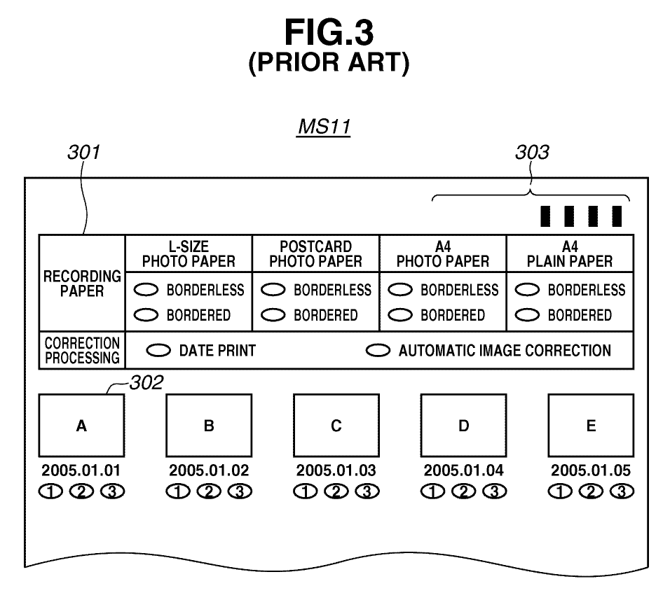

As in the conventional mark-sensing sheet MS11 illustrated in FIG. 3, the print mode settings 401 of the mark-sensing sheet MS1 illustrated in FIG. 4 includes items for specifying, for example, recording paper size, recording paper media type, bordered or borderless print.

The marking area of date print for specifying whether an image-taking date should be printed and superimposed on the image at the time of recording is printed on the mark-sensing sheet as a correction processing. In addition, there is also provided a marking area for specifying whether to perform automatic image correction. Automatic image correction is the mode to realize optimum print quality based on histograms of luminance and saturation of the image, and photo-taking conditions included in image data.

In order to enable reading of a plurality of mark-sensing sheets, marking areas, that is, “Refer to print settings on the next page” and “Add image on the next page”, are provided as options. If “Refer to print setting on the next page” is marked, the settings of recording paper and correction processing can be set to ON to perform settings on the next mark-sensing sheet.

Therefore, if a user prints a mark-sensing sheet for specifying images that the user wishes to print and marks images to be printed, print mode setting is completed. Since a mark-sensing sheet previously used is available, the user does not need to mark on a new mark-sensing sheet.

If “Add image on the next page” is marked on the mark-sensing sheet, in addition to images specified to be printed on the current mark-sensing sheet, even images specified on another mark-sensing sheet can be treated as printing objects. If among a plurality of mark-sensing sheets, print mode settings are marked only on one mark-sensing sheet, all images specified on each mark-sensing sheet can be printed. If both “Refer to print settings on the next page” and “Add image on the next page” have been marked on those mark-sensing sheets, the similar operation can be performed.

The image information 402 includes sample images that can be specified by the mark-sensing sheet, in a reduced form, and the marking areas for specifying shooting dates and numbers of prints. In image information 402, one to three prints can be set for each image. If an image is not printed and none of those numbers are marked, the number of prints of the image is not counted.

The image number range 403 is a bar code which shows from what number to what number the images specified in the mark-sensing sheet MS-1 range within the memory card. In a case where the image number range 403 is analyzed on each mark-sensing sheet and the same image is the printing object on different mark-sensing sheets, the number of prints which is read later than the previous one can be set to ON, or can be added to the previous number of prints and constitute a total number.

As described above, when marking areas are provided for “Refer to print setting on the next page” and “Add to image on the next page” on a mark-sensing sheet and those marking areas are filled with marking, the consistency of settings on the mark-sensing sheet is not checked and control is performed to read the next mark-sensing sheet.

Settings on a newly read mark-sensing sheet are given priority and are registered as a print mode. Therefore, even when images are printed using a plurality of mark-sensing sheets, by marking items of print mode setting only on one mark-sensing sheet, all images which the user wishes to print can be printed.

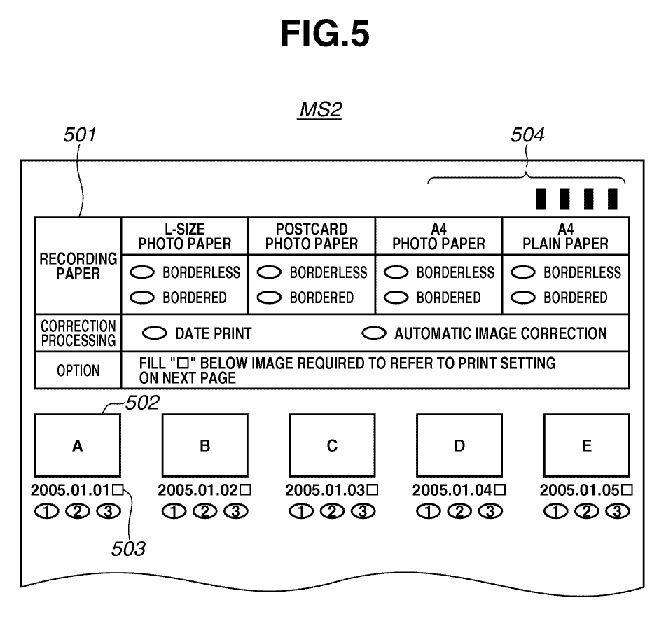

FIG. 5 is a diagram illustrating a mark-sensing sheet according to a second embodiment of the present invention. The structure and the operation flowchart of an image forming apparatus according to the present embodiment are similar to the previous embodiment, and therefore their descriptions are omitted. The items related to a recording paper and the items related to the correction process in the print mode settings 501 are the same as those of the previous embodiment, which have been described with respect to FIG. 4.

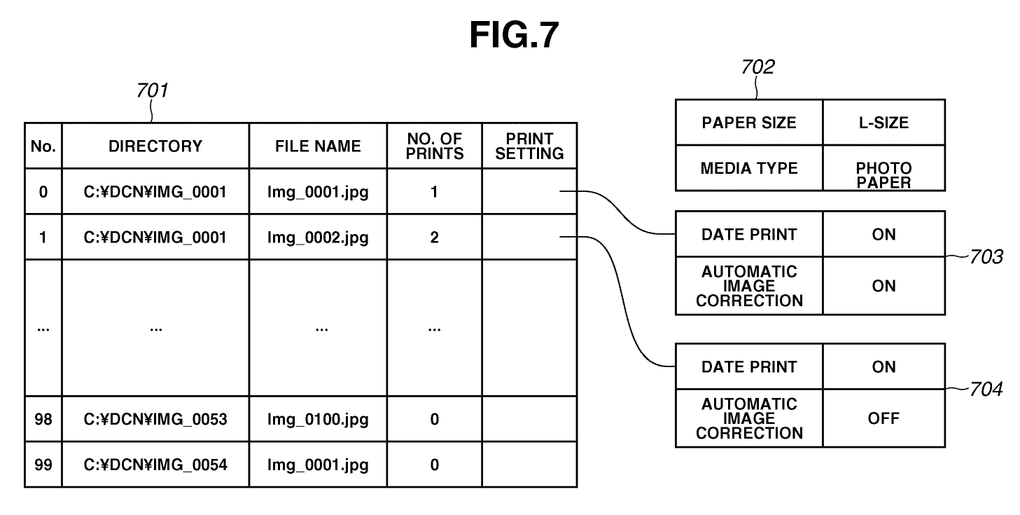

In an optional setting of the print mode settings 501, as a method for specifying the print mode for each image, a description is written which prompts the user to fill the square box 503 at a lower right position of each sample image in the image information 502. The square box 503 is provided for each image. When the box 503 of the image is filled out, the settings on a new mark-sensing sheet can be effective as to the marked image. However, even when the box 503 has been marked, if the number of prints is not specified, the process will end in an error termination due to inconsistency at the time of an analysis. The bar code representing the head number and the end number of images is the same as described in FIG. 4. [0069] FIG. 7 is a diagram illustrating a file list 701 and print mode setting items 702 used in the present embodiment.

In the present embodiment, a print mode can be set for each image. Therefore, a print setting item is provided in the file list 701, so that different setting data items 703 or 704, for example, can be specified for different images.

According to the present embodiment, in a case where a plurality of mark-sensing sheets are used and a plurality of images are selected and printed, if print setting is marked on any one of the mark-sensing sheets, the images of all mark-sensing sheets can be printed even when print setting is not marked on the other mark-sensing sheets.

Further, according to the present embodiment, if a user wishes to make some changes in a print instruction to specify print control, desired print control can be specified by revising only the items on the first mark-sensing sheet.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-168564 filed Jun. 19, 2006, which is hereby incorporated by reference herein in its entirety.

What is claimed is:

1. An image forming apparatus comprising:
a scanner unit configured to read an original document;
a memory unit configured to store image data;
a printer unit configured to print image data; and
an analysis unit configured to analyze a print specification sheet read by the scanner, wherein when the analysis unit determines that in a first print specification sheet there is no instruction to read a second print specification sheet, the printer unit prints image data based on the first print specification sheet, and when the analysis unit determines that in the first specification sheet there is an instruction to read a second print specification sheet, the printer unit prints image data specified on the first and second print specification sheets based on the first or the second print specification sheet.

2. The image forming apparatus according to claim 1, wherein the scanner unit reads the second print specification sheet based on an analysis result by the analysis unit concerning at least one of a marked item instructing to read a print instruction on the second specification sheet described in the first print specification sheet, and a marked item instructing to read image data on the second print specification sheet.

3. The image forming apparatus according to claim 1, wherein the printer prints the image data according to a print instruction on the second print specification sheet giving priority to a print instruction on the second print specification sheet when an instruction to print the image data is specified by the second print specification sheet, and the printer prints the image data according to a print instruction on the first print specification sheet giving priority to a print instruction on the first print specification sheet when an instruction to print the image data is not specified on the second print specification sheet.

4. The image forming apparatus according to claim 1, wherein the scanner reads the second print specification sheet when the analysis unit determines that in the first print specification sheet there is an instruction to read the second print specification sheet, even if there are instructions as to the same image in the first print specification sheet and the second print specification sheet.

5. The image forming apparatus according to claim 1, wherein the scanner unit reads print specification sheets until an analysis result by the analysis unit indicates that there is no instruction to read the next print specification sheet.

6. A method for controlling an image forming apparatus having a scanner configured to read an original document, a memory unit configured to store image data, and a printer unit configured to print image data, the method comprising:
analyzing a first print specification sheet;
printing image data based on a first print specification sheet, if an analysis result indicates that in the first print specification sheet there is no instruction to read a second print specification sheet; and
printing image data specified by the first and the second print specification sheets based on the first or the second print specification sheet, if the analysis result indicates that in the first print specification sheet there is an instruction to read the second specification sheet.

7. A method for controlling the image forming apparatus according to claim 6, wherein reading the second print specification sheet the scanner unit based on an analysis result by the analysis unit concerning at least one of a marked item instructing to read a print instruction on the second specification sheet described in the first print specification sheet, and a marked item instructing to read image data on the second print specification sheet.

8. A method for controlling the image forming apparatus according to claim 6, wherein printing the image data by the printer unit according to a print instruction on the second print specification sheet giving priority to a print instruction on the second print specification sheet when an instruction to print the image data is specified by the second print specification sheet, and the printer prints the image data according to a print instruction on the first print specification sheet giving priority to a print instruction on the first print specification sheet when an instruction to print the image data is not specified on the second print specification sheet.

9. A method for controlling the image forming apparatus according to claim 6, wherein reading the second print specification sheet by the scanner unit when the analysis result indicates that in the first print specification sheet there is an instruction to read the second print specification sheet, even if there are instructions as to the same image in the first print specification sheet and the second print specification sheet.

10. A method for controlling the image forming apparatus according to claim 6, wherein reading print specification sheets by the scanner unit until an analysis result indicates that there is no instruction to read the next print specification sheet.
